(19) United States
(12) Patent Application Publication
(10) Pub. No.: US 2012/0246820 A1
(43) Pub. Date: Oct. 4, 2012

(54) Steam Sauna for the Lower Body

(76) Inventor: Kevin Huynh, Chicago, IL (US)

(21) Appl. No.: 13/078,560

(22) Filed: Apr. 1, 2011

(51) Int. Cl. A61H 33/06

(52) U.S. Cl. 4/524

(57) ABSTRACT

An apparatus for hydrating the lower body portions and/or hands of a user. The apparatus includes a chamber for receiving and containing steam and the lower body portions and/or hands of the user. The chamber includes a bottom surface and a wall structure extending upwardly from the bottom surface. Steam from the steam generator is transported via a hose in communication with the steam generator and the chamber. Inside the chamber, the hose is in communication with a steam distribution apparatus. Steam passing through the steam distribution apparatus fills the chamber.

### BACKGROUND OF THE INVENTION

1. Field of the Invention

The present invention relates to an apparatus for hydrating and massaging the lower body portions and hands of a user.

2. Description of the Prior Art

Foot hydrators and massagers are well known. The foot hydrators and massagers of the prior art typically utilize hot water, water agitation, and a plurality of raised nodes to massage the feet. None of the prior art utilizes steam to hydrate the entire lower body portions. The prior art also does not contain cut-outs in the walls of hydrators to provide support underneath the user's knees. Further, the prior art does not contain a foot massager with raised rotating nodes combined with a steam outlet to massage or hydrate the feet. None of the prior art can be combined in this way to suggest these necessary modifications to increase hydration and circulation to the user's entire lower body portions. There is no teaching, suggestion, or motivation in the prior art that would have enabled a person of ordinary skill in the art to modify any prior art foot massager or bath apparatus to allow steam and raised nodes to hydrate and massage a user's entire lower body portions and hands.

U.S. Pat. No. 2,265,484 discloses the use of boiler or electric heater generated steam to aid in relieving medical ailments, however, it does not disclose any form of massage and is limited to use by small parts of the body such as the hands and neck. A person having ordinary skill in the art would have to enlarge the steam chamber, improve the steam generator, add a steam distribution apparatus, and include a foot massager.

U.S. Patent Publication 2006/0195979 discloses the use of hot and cold water and raised nodes to massage the user's feet, however, the steam generated by the device is an unintended side effect of using hot water. A person having ordinary skill in the art would have to enlarge the steam chamber, improve the steam generator, add a steam distribution apparatus, and include a foot massager.

U.S. Pat. No. 6,393,633 discloses the use of hot water and raised nodes to massage the user's feet, however, it does not disclose the use of steam to hydrate the feet and it does not treat the user's entire lower body portions. A person having ordinary skill in the art would have to add a steam chamber, a steam generator, and a steam distribution apparatus to the foot massager disclosed in the '633 patent.

The prior art to date does not disclose a steam chamber with cut-outs to provide support underneath the user's knees, a steam generator, a steam distribution apparatus, and a foot massager with a steam outlet to hydrate and massage the user's entire lower body portions and hands. None of the prior art can be combined in this way to suggest these necessary modifications. There is no teaching, suggestion, or motivation that would have enabled a person of ordinary skill in the art to modify any prior art foot massager or bath apparatus to allow steam and raised nodes to hydrate and massage a user's entire lower body portions and hands.

A primary object of the present invention is to provide a user with a pleasurable and relaxing aromatic and hydrating experience that softens the user's entire lower body portions and hands.

Another object of the invention is to provide a user with a pleasurable and relaxing foot massage.

### SUMMARY OF THE INVENTION

The steam sauna of the present invention comprises a container having a chamber for receiving steam and a user's lower body portions and hands. The steam is generated by a steam generator and fed into the chamber via a hose connected to the steam generator. The hose passes through the wall structure of the container and then connects to a steam distribution apparatus inside the container.

The steam distribution apparatus comprises a lower portion and a lid. The lower portion and the lid include a plurality of apertures that allow steam to pass through an internal chamber of the steam distribution apparatus and into the chamber of the container. A platform in the internal chamber formed between the lower portion and the lid is adapted to receive a fragrant odorant product which is activated upon contact with the steam.

The steam passing through the steam distribution apparatus must then pass through a foot rest located over the steam distribution apparatus. In one embodiment of the invention, the foot rest includes rotatable, raised nodes adapted to massage the user's feet.

### BRIEF DESCRIPTION OF THE DRAWINGS

The present invention is further described with reference to the accompanying drawings in which:

FIG. 1 is a front and top perspective view of an embodiment of the steam sauna;

FIG. 2 is an exploded view of the embodiment of the sauna of FIG. 1;

FIG. 3 is a top view of the bottom and inside of the container of the sauna of FIG. 1, showing the steam distribution apparatus in place taken along line 3-3 of FIG. 2;

FIG. 4 is a section view of an embodiment of the footrest nodes of the sauna of FIG. 2, taken along line 4-4 of FIG. 2;

FIG. 5 is a side view of the foot massager that forms part of an embodiment of the present invention;

FIG. 6 is a top view of the foot massager of FIG. 5;

FIG. 7 is a bottom view of the foot massager of FIG. 5; and

FIG. 8 is a top view of the bottom of the inside of the container with the foot massager in place.

### DETAILED DESCRIPTION OF THE ILLUSTRATED EMBODIMENTS

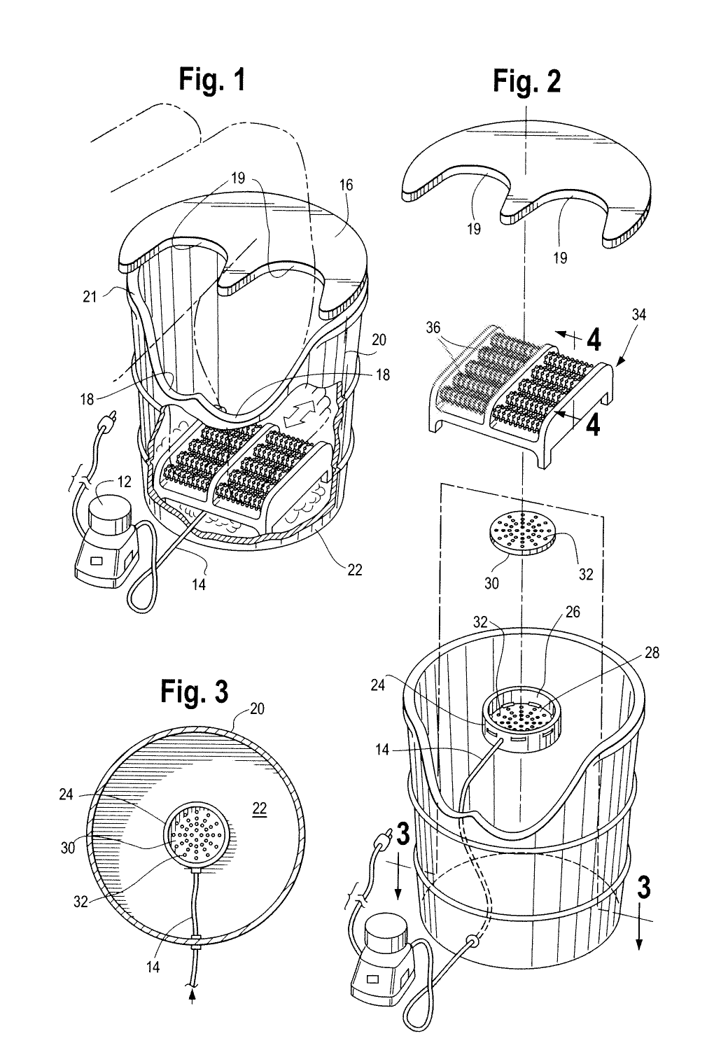

Referring to FIGS. 1 and 2, the steam sauna of the invention comprises a container having a chamber 10. Chamber 10 has a wall structure 20 open at the top end 21 and a bottom surface 22. The top end 21 of wall structure 20 supports a removable lid 16. The wall structure 20 includes at least one cut-out portion of two adjacent curvilinear forms 18 on an edge of wall structure 20, which curvilinear forms 18 are adapted to receive and support the lower body parts of the user. The wall structure 20 also receives a hose or tube 14, which is in communication on one end to a steam generator 12 located outside of chamber 10, and with chamber 10 at the opposite end. As seen in FIG. 2, removable lid 16 also includes two adjacent curvilinear forms 19, for purposes to be explained.

Referring to FIGS. 2 and 3, the end of hose 14 passing through the wall structure 20 of chamber 10 is in communication with the steam distribution apparatus 24. The steam distribution apparatus 24 is located on bottom surface 22 inside chamber 10. The steam distribution apparatus 24 includes an internal chamber 26, a platform 28, and a cover 30. The internal chamber 26 of the steam distribution apparatus 24 is adapted to receive the steam through the hose 14 from the steam generator 12. The platform 28 and the cover 30 each include apertures 32 to allow the steam to pass through the steam distribution apparatus 24 into the chamber 10. The internal chamber 26 is adapted to receive a fragrant odorant product which is activated upon contact with the steam, as is known in the prior art.

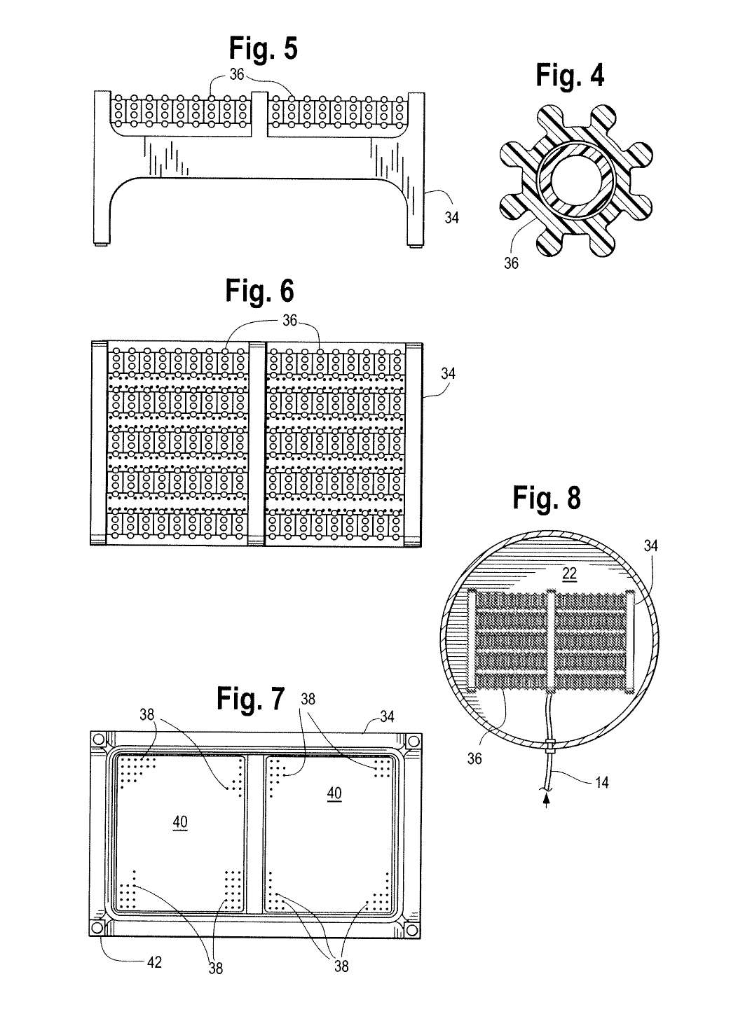

Referring to FIGS. 1 and 2, the chamber 10 also may include a foot rest 34 located over the steam distribution apparatus 24. The foot rest 34 contains rotatable, raised nodes 36 (FIGS. 4-6, 8) adapted to massage the user's feet while supporting the user's feet.

Referring particularly to FIG. 7, the bottom surface 40 of foot rest 34 contains apertures 38 to allow steam emanating from the steam distribution apparatus 24 to pass through the foot rest 34 to the user's feet.

Referring particularly to FIG. 8, the legs 42 of the foot rest 34 rest on the bottom surface 22 of chamber 10 over steam distribution apparatus 24.

When using the steam sauna of the present invention, users place their lower body portions and hands over curvilinear forms 18 and into chamber 10, placing the feet on foot rest 34. Lid 16 is then placed over top end 21 of chamber 20, with curvilinear forms 19 extending adjacent the lower body portions and adjacent curvilinear forms 18 of wall structure 20. If desired, a towel may be placed over lid 16 and the lower body portions and hands of the user to assist in retaining steam in chamber 10. The hands are placed under the towel to be in contact with the steam. Steam generated by steam generator 12 and aroma passing through the steam distribution apparatus 24 and foot rest 34 hydrate and massage the user's lower body and hands providing the user with a pleasurable and relaxing experience.

As mentioned previously, the platform 28 of the steam distribution apparatus 24 may support a fragrant odorant product wherein the odorant is released from the product upon contact with the steam. The odorant can provide one or more of several aromas that are known to provide a pleasant hydrating and massage experience.

One practical use of the foot sauna and massage apparatus described above is in a salon setting, where the container with chamber 10 is placed at or near the feet of a user who is seated and is having his or her hair treated, is receiving a manicuring service, is receiving a facial, or is being provided with an upper body massage. The lower body parts and hands are simultaneously placed in chamber 10 as described above. Steam generator 12 is then activated to drive steam through hose 14 and into steam distribution apparatus 24. The user moves his or her feet in a reciprocal motion over the raised, rotatable nodes 36 of foot rest 34 to receive a foot massage. Due to the heat generated by the steam, the user's skin pores will open and the skin will soften to help remove calluses. Additionally, the foot and hand sauna and massage apparatus can be used as a stand alone system in a salon, or at the user's home.

In the illustrated embodiment of the invention, steam generator 12 includes controls that adjust the temperature and rate of steam flow entering chamber 10, as is known in the art. Setting the steam generator 12 at the highest temperature setting will sanitize the foot rest. The steam generator 12 may also include an automatic shut-off valve that ceases operation of the steam generator when the water reservoir in the steam generator 12 reaches a predetermined low level. Unlike traditional pedicure services, which require four to five gallons of water, the steam generator 12 only requires three to four ounces of water.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

1. An apparatus for hydrating the lower body portions and/or hands of a user, the apparatus comprising:
a. a container having a chamber, the chamber adapted to receive steam and the lower body portions and/or hands of the user; the chamber including a bottom surface and a wall structure extending upwardly from the bottom surface;
b. the wall structure having at least one cut-out section on an edge of the wall structure located at an end of the container opposite the bottom surface, the section adapted to enable a user to be in a sitting position and receive steam on the lower body portions;
c. a steam generator in communication with the chamber; and
d. a steam distribution apparatus in the chamber, the steam distribution apparatus in communication with the steam generator.

2. The apparatus of claim 1, wherein the steam generator includes a hose in communication with the wall structure of the chamber, the hose also communicating between the steam generator and the steam distribution apparatus.

3. The apparatus of claim 1, including a removable lid supported by the top of the wall structure.

4. The apparatus of claim 1, further including a foot rest located over the steam distribution apparatus, the steam distribution apparatus and the foot rest supported by the bottom surface of the chamber.

5. The apparatus of claim 1, wherein the steam distribution apparatus has apertures on an upper surface, said apertures adapted to allow steam to pass through the steam distribution apparatus.

6. The apparatus of claim 4, wherein the foot rest is adapted to support the feet of the user above the steam distribution apparatus.

7. The apparatus of claim 4, wherein the foot rest includes rotatable, raised nodes adapted to massage the user's feet.

8. The apparatus of claim 4, wherein the foot rest includes apertures on a bottom surface, said apertures adapted to allow steam to pass through the foot rest.

9. (canceled)

10. The apparatus of claim 1, wherein the at least one cut-out portion comprises two adjacent curvilinear cut-out portions, the two cut-out portions adapted to receive the lower body parts of the user when the lower body parts are inserted into the chamber.

11. The apparatus of claim 1, wherein the top of the wall structure supports a removable lid; the lid comprising at least one cut-out portion on an edge of the lid.

12. The apparatus of claim 10, wherein the top of the wall structure supports a removable lid, the removable lid comprising two adjacent curvilinear cut-out portions adapted to extend adjacent the two cut-out portions of the wall structure when the lid is placed on the wall structure; the two cut-out portions of the wall structure and the two cut-out portions of the lid forming an entrance communicating with the chamber when the lid is supported by the wall structure, the entrance adapted to receive the lower body portions of the user when the feet of the user are inserted into the chamber.

13. The apparatus of claim 1, wherein the steam distribution apparatus includes an internal chamber, the internal chamber adapted to receive the steam from the steam generator; a platform in the internal chamber, the platform having apertures allowing steam to pass through the internal chamber and into the chamber of the container.

14. The apparatus of claim 13, wherein the internal chamber of the steam distribution apparatus includes an apertured cover disposed above the platform; a volume formed between the aperture platform and the apertured cover of the steam distribution apparatus; the volume adapted to receive a fragrant odorant product activated upon contact with the steam.
